(19) United States
(12) Patent Application Publication
(10) Pub. No.: US 2017/0305008 A1
(43) Pub. Date: Oct. 26, 2017

(54) HANDLE FOR A SCREWDRIVER

(71) Applicant: FRENWAY PRODUCTS INC., Taipei City (TW)

(72) Inventor: Scott Wang, TAIPEI CITY (TW)

(21) Appl. No.: 15/139,294

(22) Filed: Apr. 26, 2016

(51) Int. Cl. B25G 1/10; B25G 1/00; B25B 15/02

(52) U.S. Cl. CPC B25G 1/102; B25B 15/02; B25G 1/005

(57) ABSTRACT

A screwdriver includes a shank having a driving end and a connection end which is fixed to a handle. The handle has a core portion which is mounted to the connection end of the shank by way of injection molding. Multiple first portions and multiple second portions are alternatively attached to the outside of the core portion. The first portions are made of material that is softer than that of the second portions so as to provide comfortable grasp to the user's hand.

### BACKGROUND OF THE INVENTION

### 1. Fields of the invention

The present invention relates to a handle of a screwdriver, and more particularly, to a handle of a screwdriver with soft portions and solid portions to provide a comfortable operation feature.

### 2. Descriptions of Related Art

The conventional screwdriver generally includes a handle and a shank which is fixed to the handle at the first end thereof, and a driving end is formed on the second end of the shank. The driving end is shaped to be engaged with an object such as a bolt, the user holds the handle to rotate the screwdriver to tighten or loosen the bolt.

The user has to hold the handle firmly to operate the screwdriver, especially when the bolt needs a significant force to be loosened. Usually, the conventional handles are made by plastic which is stiff, and some of the handles have grooves/ridges for providing friction between the handle and the user's hand, such that the user can apply torque to the screwdriver to efficiently rotate the bolt. Nevertheless, the friction also makes the user feel uncomfortable, in some situations, the user's skin may be hurt.

The present invention intends to provide a handle of a screwdriver, and the handle includes soft portions which provide comfortable grasp to the user to eliminate the shortcomings mentioned above.

### SUMMARY OF THE INVENTION

The present invention relates to a screwdriver and comprises a shank having a driving end and a connection end. A handle has a first end connected to the connection end. The handle has a core portion which is mounted to the connection end of the shank by way of injection molding. Multiple first portions and multiple second portions are alternatively attached to the outside of the core portion.

Preferably, the first portions each have Shore hardness scale between 15 to 50.

Preferably, the connection portion has multiple engaging units 3 connected to an outside thereof, the engaging units 3 are connected along an axial direction of the shank 1 at even distances.

Preferably, the engaging units each have multiple protrusions which are located on a common plane.

Preferably, there are two to four engaging units located along the connection portion of the shank.

Preferably, the cross sectional area of each protrusion is rectangular or semi-circular.

Preferably, the handle has a through hole defined through the second end thereof The axis of the through hole is located on a plane where the axis of the shank is located thereon. The axis of the through hole is perpendicular to the axis of the shank.

Preferably, the handle is a pear-like handle which includes a neck portion and a grasp portion which is wider than the neck portion which is located close to the first end of the handle.

Preferably, the first portions each are made of thermo-elastic material.

Preferably, the core portion is made of Polypropylene.

The present invention has advantages which are that the protrusions of the engaging units on the shank bear a large torque so that the shank does not spin relative to the core portion of the handle. There is a through hole defined in the handle so that the user may extend a rod through the through hole to use the screwdriver as a T-bar to apply a lager torque. The first portions and the second portions of the core portion are easily manufactured. The handle of the present invention provides comfortable grasp feel and protects the user's hand as well.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the screwdriver of the present invention;

FIG. 2 is a cross sectional view, taken along line II-II in FIG. 1;

FIG. 3 is a cross sectional view, taken along line III-III in FIG. 1;

FIG. 4 is a cross sectional view, taken along line IV-IV in FIG. 1;

FIG. 5 shows that the protrusions each have a semi-circular cross sectional area, and

FIG. 6 shows a rod extends through the through hole of the handle of the screwdriver of the present invention.

### DETAILED DESCRIPTION OF THE PREFERRED EMBODIMENT

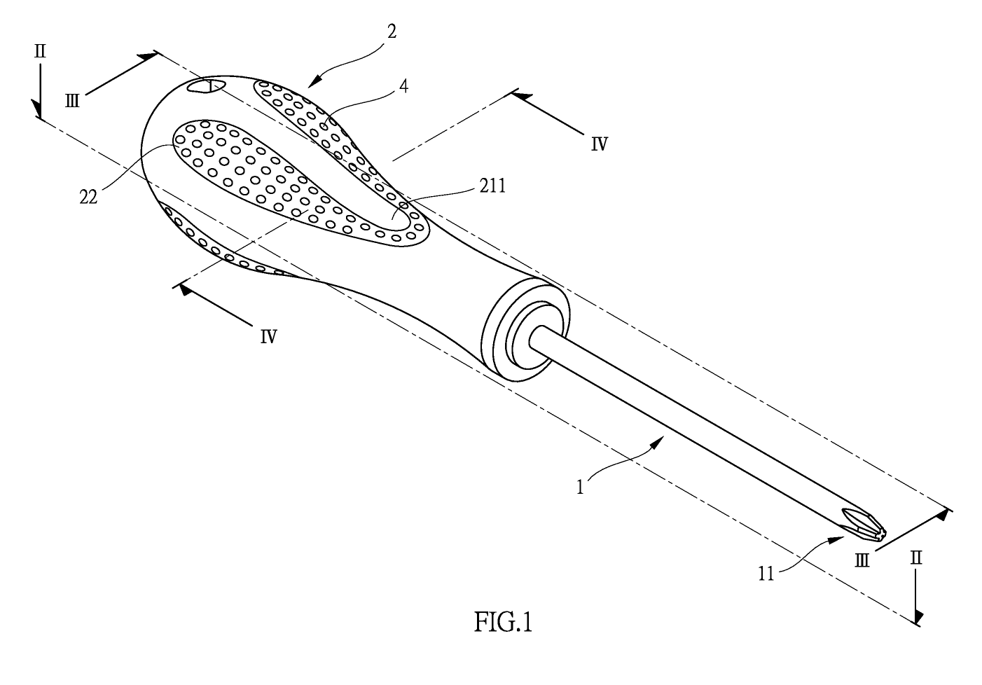

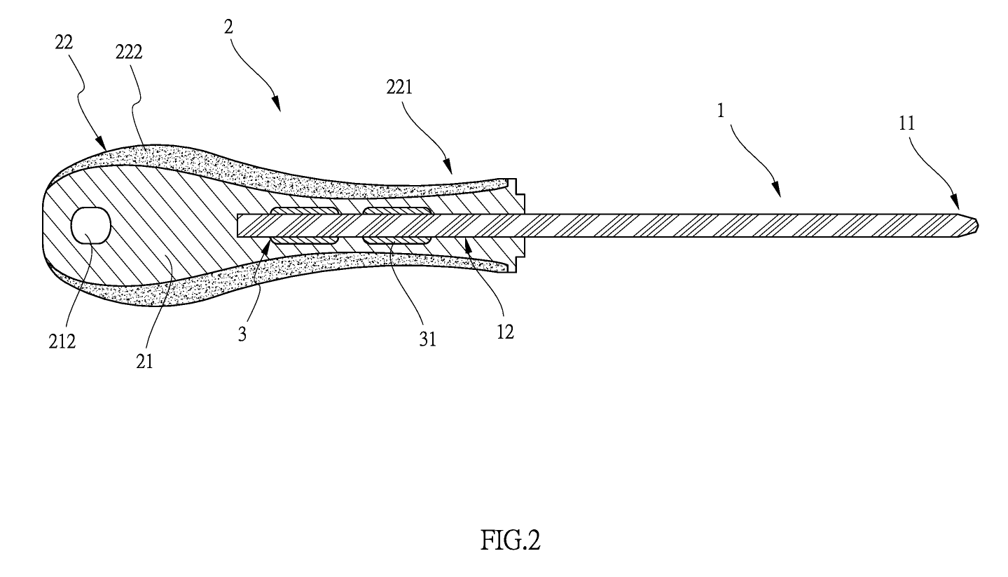

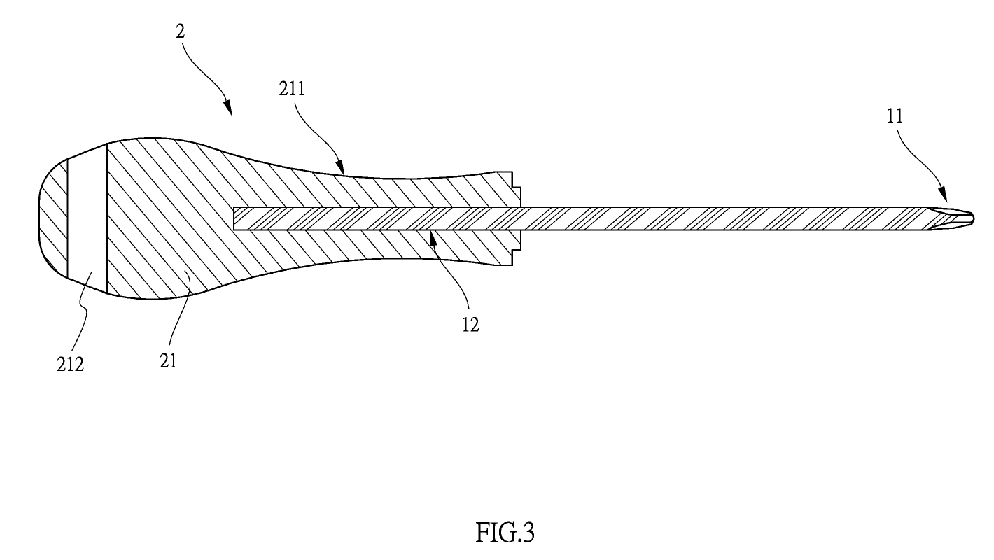

Referring to FIGS. 1 to 4, the screwdriver of the present invention comprises a shank 1 having a driving end 11 and a connection end 12, wherein the driving end 11 can be a cabinet end, Phillips end or any known end.

A handle 2 has a first end connected to the connection end 12, and the handle 2 has a core portion 21 which is mounted to the connection end 12 of the shank 1 by way of injection molding. Multiple first portions 22 and multiple second portions 211 are alternatively attached to the outside of the core portion 21. The first portions 22 each have Shore hardness scale between 15 to 50. The second portions 221 are stiffer than that of the first portions 22 so that the handle 2 provides a comfortable grasp to the user, while a larger torque can be applied to an object such as a bolt.

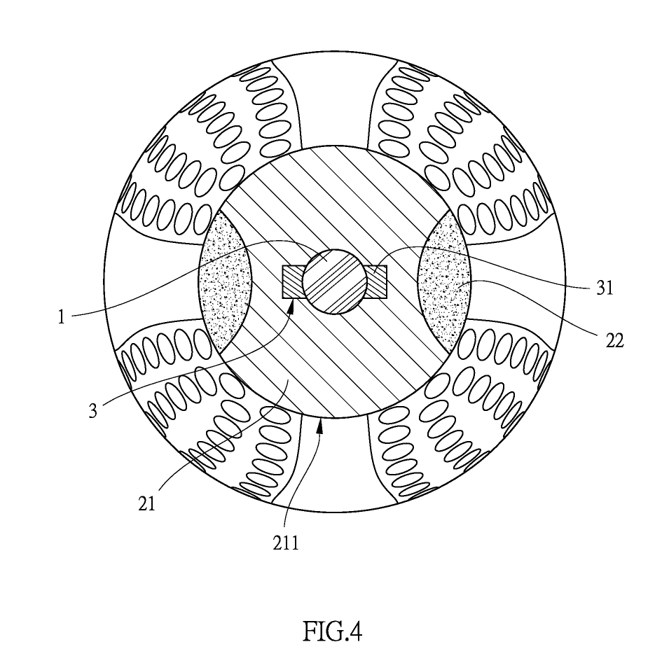

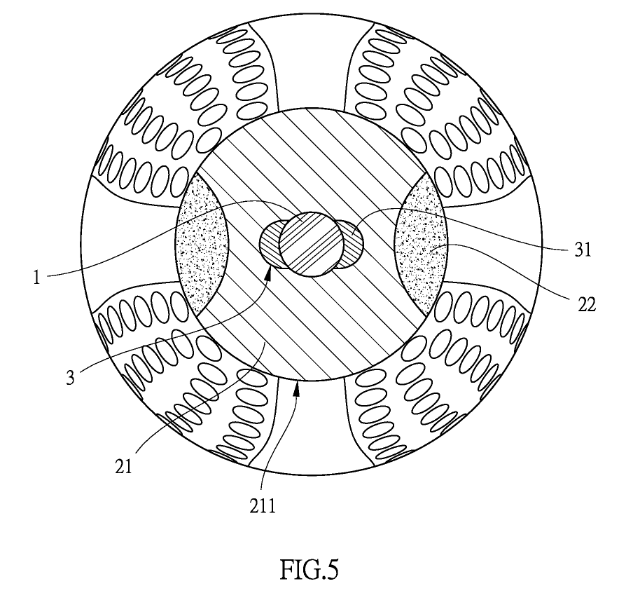

The connection portion 12 has multiple engaging units 3 connected to the outside thereof, and the engaging units 3 are connected along the axial direction of the shank 1 at even distances. The engaging units 3 each have multiple protrusions 31 which are located at a common plane. The protrusions 31 extend along the axial direction of the shank 1. In one embodiment, there are 2 to 4 engaging units 3 located along the connection portion 12 of the shank 1. When the core portion 21 is connected to the shank 1 by way of the injection molding, the material of the core portion 21 is firmly connected to the shank 1 and fills between the engaging units 3. The cross sectional area of each protrusion 31 can be rectangular or semi-circular as shown in FIGS. 4 and 5. The protrusions 31 of the engaging units 3 on the shank 1 bear a large torque, and the shank 1 does not spin relative to the core portion 21 of the handle 2.

The handle 2 is a pear-like handle which includes a neck portion 221 and a grasp portion 222, wherein the grasp portion 222 is wider than the neck portion 221 which is located close to the first end of the handle 2. The first portions 22 each are made of thermo-elastic material, and have Shore hardness scale between 15 to 50. The core portion 21 is made of Polypropylene.

Specifically, the first portions 22 include the neck portion 221 and a grasp portion 222, wherein the thickness of the neck portion 221 is 2 mm, and the thickness of the grasp portion 222 is 6 mm Bosses protrude from the outer surface of each first portion 22 to provide further anti-slip feature.

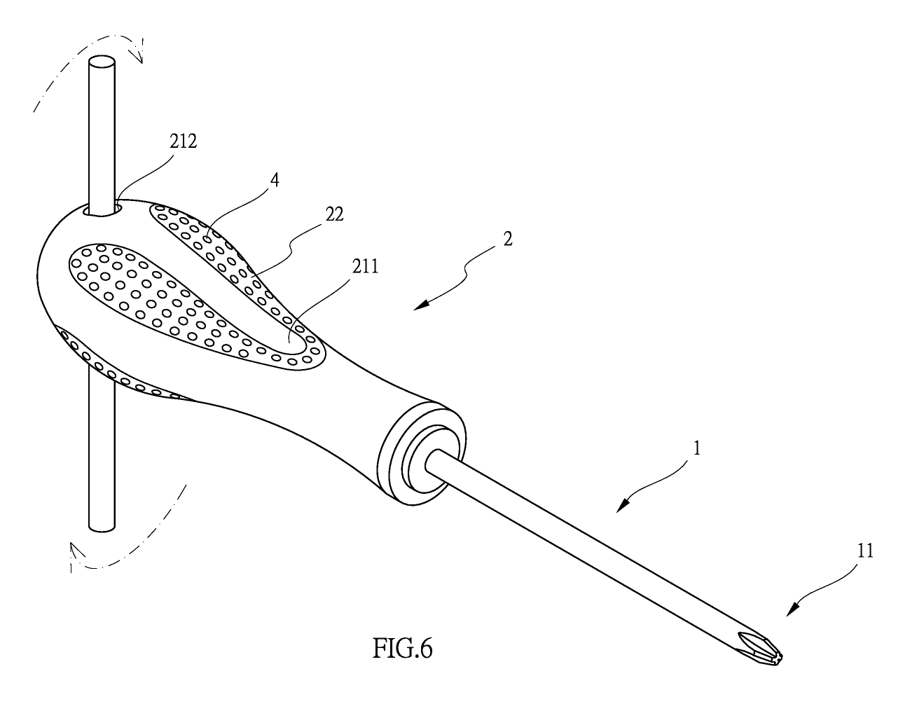

As shown in FIG. 6, the handle 1 has a through hole 212 defined through the second end thereof The axis of the through hole 212 is located on a plane where an axis of the shank 1 is located thereon. The axis of the through hole 212 is perpendicular to the axis of the shank 1. When the screwdriver is used to loosen a tight object, the user may extend a rod through the through hole 212 to use the screwdriver as a T-bar to apply a lager torque.

The handle is easily manufactured and provide better and comfortable grasp.

While we have shown and described the embodiment in accordance with the present invention, it should be clear to those skilled in the art that further embodiments may be made without departing from the scope of the present invention.

What is claimed is:

1. A screwdriver comprising:
a shank having a driving end and a connection end, and
a handle having a first end connected to the connection end, the handle having a core portion which is mounted to the connection end of the shank by way of injection molding, multiple first portions and multiple second portions alternatively attached to an outside of the core portion.

2. The screwdriver as claimed in claim 1, wherein the first portions each have Shore hardness scale between 15 to 50.

3. The screwdriver as claimed in claim 1, wherein the connection portion has multiple engaging units connected to an outside thereof, the engaging units are connected along an axial direction of the shank at even distances.

4. The screwdriver as claimed in claim 3, wherein the engaging units each have multiple protrusions which are located at a common plane.

5. The screwdriver as claimed in claim 4, wherein there are 2 to 4 engaging units located along the connection portion of the shank.

6. The screwdriver as claimed in claim 5, wherein a cross sectional area of each protrusion is rectangular or semi-circular.

7. The screwdriver as claimed in claim 1, wherein the handle has a through hole defined through a second end thereof, an axis of the through hole is located on a plane where an axis of the shank is located thereon, the axis of the through hole is perpendicular to the axis of the shank.

8. The screwdriver as claimed in claim 1, wherein the handle is a pear-like handle which includes a neck portion and a grasp portion which is wider than the neck portion which is located close to the first end of the handle.

9. The screwdriver as claimed in claim 1, wherein the first portions each are made of thermo-elastic material.

10. The screwdriver as claimed in claim 1, wherein the core portion is made of Polypropylene.
